(19) United States
(12) Patent Application Publication
(10) Pub. No.: US 2014/0278750 A1
(43) Pub. Date: Sep. 18, 2014

(54) SYSTEM AND METHOD FOR RECLASSIFYING SMALL BUSINESS CUSTOMERS

(71) Applicant: Bank of America Corporation, Charlotte, NC (US)

(72) Inventors: Arya Kumar Vedabrata, Bhubaneswar (IN); Kiran Tnvr, Hyderabad (IN); Bibhudatta Jena, Bhubaneswar (IN); Sudeshna Banerjee, Waxhaw, NC (US); Samir B. Pawar, Charlotte, NC (US); Suresh Raju Rudraraju, Hyderabad (IN)

(21) Appl. No.: 13/938,779

(22) Filed: Jul. 10, 2013

Related U.S. Application Data
(60) Provisional application No. 61/791,646, filed on Mar. 15, 2013.

(51) Int. Cl. G06Q 30/02

(52) U.S. Cl. CPC G06Q 30/0201
USPC 705/7.29

(57) ABSTRACT

In certain embodiments, a system includes one or more memory modules operable to store business transaction data for a plurality of customers of an enterprise, the business transaction data including a size classification for each of the plurality of customers. The system further includes one or more processing modules operable to determine, based on the business transaction data, a first list of customers comprising one or more of the plurality of customers that have a particular size classification. The one or more processing modules are further operable to access publicly-available financial information (including revenue information) for each of the one or more customers of the determined first list of customers and determine, based on the accessed publicly-available financial information, a second list of customers comprising one or more customers of the first list of customers that have revenue exceeding a predetermined amount. The one or more processing modules are further operable to store, in the one or more memory modules, a new size classification for each of the one or more customers of the second list.

### RELATED APPLICATION

This application claims the benefit under 35 U.S.C. §119(e) of U.S. Provisional Application Ser. No. 61/791,646 filed Mar. 15, 2013.

### TECHNICAL FIELD

This disclosure relates generally to data analysis, and more particularly to a system and method for reclassifying small business customers.

### BACKGROUND

A financial institution may collect and internally store large amounts of data (e.g., data regarding financial transactions) in providing financial services to both consumer and business customers. Additionally, the financial institution may have access to large amounts of publicly available data regarding those same customers (e.g., data available in reports offered by companies such as Dun & Bradstreet, Inc.). An inability to properly leverage the internally stored and/or publicly-available data, however, may prevent the financial institution from developing relationships with potential customers and/or adequately cultivating the relationships with existing customers.

### SUMMARY OF EXAMPLE EMBODIMENTS

According to embodiments of the present disclosure, disadvantages and problems associated with a data communication and analytics platform may be reduced or eliminated.

In certain embodiments, a system includes one or more memory modules operable to store business transaction data for a plurality of customers of an enterprise, the business transaction data including a size classification for each of the plurality of customers. The system further includes one or more processing modules operable to determine, based on the business transaction data, a first list of customers comprising one or more of the plurality of customers that have a particular size classification. The one or more processing modules are further operable to access publicly-available financial information (including revenue information) for each of the one or more customers of the determined first list of customers and determine, based on the accessed publicly-available financial information, a second list of customers comprising one or more customers of the first list of customers that have revenue exceeding a predetermined amount. The one or more processing modules are further operable to store, in the one or more memory modules, a new size classification for each of the one or more customers of the second list.

Certain embodiments of the present disclosure may provide one or more technical advantages. For example, because internal classifications for customers may govern the types of products that an enterprise (e.g., a financial institution) offers to those customers, knowledge of those small business customers that have grown beyond a certain size may allow the enterprise to reclassify those businesses (e.g., as mid-level business) such that appropriate products and/or services may be offered to those businesses.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and for further features and advantages thereof, reference is now made to the following description taken in conjunction with the accompanying drawings, in which:

FIG. 1 illustrates a data analysis system, according to certain embodiments of the present disclosure; and

FIG. 2 illustrates an example method for reclassifying small business customers, according to certain embodiments of the present disclosure.

### DETAILED DESCRIPTION

FIG. 1 illustrates a data analysis system 100, according to certain embodiments of the present disclosure. System 100 may include a user system 102 and a corporate action and knowledge platform (CAKP) 104. CAKP 104 may include one or more server systems 106 and one or more databases 108 (each depicted and described in the singular for purposes of simplicity). User system 102 may be configured to communicate with CAKP 104 via a network 110. Additionally, CAKP 104 may access information from one or more external data sources 112 (e.g., via network 110). Although this particular implementation of system 100 is illustrated and primarily described, the present invention contemplates any suitable implementation of system 100 according to particular needs.

In general, system 100 is operable to generate actionable data for an enterprise (e.g., a financial institution) based on an analysis of (1) pre-existing, internally stored data (e.g., business transaction data 118 stored in database 108), and/or (2) data stored in publicly-available, external databases (e.g., publicly-available financial data 120 stored in external data source 112). In certain embodiments, the generated actionable data may include a list of corporate mergers or acquisitions, a list of rapidly-growing businesses (e.g., growing companies that are current customers, previous customers, or potential customers of a financial institution), a list of small business customers of a financial institution that have grown beyond a certain size (e.g., based on yearly revenues), or a list of potential mergers or acquisitions. Determining this actionable data may also provide a number of benefits. For example, knowledge of corporate mergers and acquisitions may allow a financial institution to better manage credit risk (as any merger or acquisition should result in a revision or at least a review of a credit risk rating of the acquiring companies). Additionally, knowledge of growing businesses may allow a financial institution to further develop existing relationships or develop new relationships with those businesses. Additionally, knowledge of those small business customers that have grown beyond a certain size may allow a financial institution to reclassify those businesses (e.g., as mid-level business) such that appropriate products and/or services may be offered to those businesses. Finally, knowledge of potential mergers or acquisitions may allow a financial institution to better assist in identifying merger/acquisition targets (e.g., to the investment banking industry).

Turning to the above-discussed components of system 100, user system 102 may include any suitable device or combination of devices operable to allow a user (e.g., an enterprise employee or other authorized personnel) to access all or a portion of the functionality associated with CAKP 104 (as described in detail below). For example, user system 102 may include one or more computer systems at one or more locations. A computer system, as used herein, may include a personal computer, workstation, network computer, kiosk, wireless data port, personal data assistant (PDA), one or more processors within these or other devices, or any other suitable processing device. Additionally, each computer system may include any appropriate input devices (such as a keypad, touch screen, mouse, or other device that can accept information), output devices, mass storage media, or other suitable components for receiving, processing, storing, and communicating data. Both the input device and output device may include fixed or removable storage media such as a magnetic computer disk, CD-ROM, or other suitable media.

In certain embodiments, user system 102 may include a graphical user interface (GUI) 114, which may be delivered using an online portal, hypertext mark-up language (HTML) pages for display and data capture, or in any other suitable manner. GUI 114 may allow a user of user system 102 to interact with other components of system 100. For example, GUI 114 may allow a user of user system 102 to access all or a portion of the functionality associated with CAKP 104 (as described in further detail below). Although a single user system is depicted for purposes of simplicity, the present disclosure contemplates that system 100 may include any suitable number of user systems, according to particular needs.

User system 102 may be communicatively coupled to CAKP 104 via network 110. Network 110 may facilitate wireless or wireline communication and may communicate, for example, IP packets, Frame Relay frames, Asynchronous Transfer Mode (ATM) cells, voice, video, data, and other suitable information between network addresses. Network 110 may include one or more local area networks (LANs), radio access networks (RANs), metropolitan area networks (MANs), wide area networks (WANs), all or a portion of the global computer network known as the Internet, and/or any other communication system or systems at one or more locations.

CAKP 104 may include any suitable system operable to analyze internally stored data (e.g., business transaction data 118 stored in database 108 of CAKP 104, as described in further detail below) and/or externally stored data (e.g., publicly-available financial information 120 from one or more external data sources 112) to generate actionable knowledge regarding current and/or potential customers (as described in further detail below). In certain embodiments, CAKP 104 may include a server system 106 and a database 108. Server system 106 may include one or more electronic computing devices operable to receive, transmit, process, and store data associated with system 100. For example, server system 106 may include one or more general-purpose PCs, Macintoshes, workstations, Unix-based computers, server computers, one or more server pools, or any other suitable devices. In short, server system 106 may include any suitable combination of software, firmware, and hardware. Although a single server system 106 is illustrated, the present disclosure contemplates system 100 including any suitable number of server systems 106. Moreover, although referred to as a “server system,” the present disclosure contemplates server system 106 comprising any suitable type of processing device or devices.

Server system 106 may include one or more processing modules 116, each of which may include one or more microprocessors, controllers, or any other suitable computing devices or resources. Processing modules 116 may work, either alone or with other components of system 100, to provide a portion or all of the functionality of system 100 described herein. Server system 106 may additionally include (or be communicatively coupled to) a database 108. Database 108 may comprise any suitable memory module and may take the form of volatile or non-volatile memory, including, without limitation, magnetic media, optical media, random access memory (RAM), read-only memory (ROM), removable media, or any other suitable local or remote memory component.

In certain embodiments, database 108 of CAKP 104 may store business transaction data 118 for one or more business customers of an enterprise. Business transaction data 118 may include any suitable information generated and/or gathered by the enterprise that corresponds to the financial activity of a business customer of the enterprise. For example, business transaction data 118 may be historical data or data from separate channels, such as ACH transaction data, credit card transaction data, wire transaction data, or any other suitable data concerning transactions of business customers of an enterprise. As specific examples, business transaction data 118 may include the name of a business customer, identifying information for the business customer (e.g., a tax ID), an internal classification of the business customer (e.g., a small business classification), demographic information for the business customer, risk rating information for the business customer, parent-subsidiary information for the business customer, product/account information for the business customer, financial transaction data for the business customer (e.g., an amount of a transactions and who the transaction was with), and any other pertinent information regarding the business customer. Additionally, the business transaction data 118 may include a categorization and/or purpose of the transaction to arrive at a category of the transaction. In certain embodiments, the categorization of transactions may provide text mining and analytic capabilities. In certain embodiments, business transaction data 118 is generated and maintained as part of the ordinary course of business for the enterprise.

Although a single file containing business transaction data 118 is depicted and described as being stored in a single database (i.e., database 108 of CAKP 104), the present disclosure contemplates the above-described business transaction data 118 being divided in any suitable manner among a number of files residing on any suitable number of databases within an enterprise, according to particular needs.

In certain embodiments, CAKP 104 may be able to access publicly-available financial information 120 regarding certain businesses (e.g., customer and non-customer businesses) from one or more external data sources 112 (e.g., via network 110). As just one example, publicly-available financial information 120 may include revenues, profitability, growth, liquidity, efficiency, or any other suitable information and may be accessed from external data sources 112 such as Dun and Bradstreet reports, an SEC database (e.g., accessible via the Internet), or any other suitable location.

In certain embodiments, server system 110 may include data analysis logic 122. Data analysis logic 122 may include any suitable combination of hardware, firmware, and software operable to analyze business transaction data 118 and/or publicly-available financial information 120 to generate actionable information for an enterprise, as described in detail below. In certain embodiments, data analysis logic 122 may additionally be operable to generate a graphical display (e.g., via GUI 114) representing the determined actionable data such that the data may be displayed to a user of user system 102.

In certain embodiments, data analysis logic 122 may be operable to analyze business transaction data 118 to determine a list of mergers or acquisitions. For example, an enterprise may maintain business transaction data 118 that includes monthly expenditure data for its business customers (e.g., expenditures for the payment of employee salaries, expenditures on the purchase of goods/services, or any other suitable category of expenditure). Data analysis logic 122 may be operable to analyze one or more categories of the business transaction data 118 to identify a first business customer (Company A) having a spike in monthly expenditures (e.g., an increase of more than a predetermined dollar amount or percentage amount as compared to the previous month). Data analysis logic 122 may be further operable to analyze the one or more categories of the business transaction data 118 to identify a second business customer (Company B) having a decrease in monthly expenditures corresponding to the identified spike associated with the first business customer (Company A). As one particular example, Company A may be identified as having a $100,000 increase in salary expenditures in the month of February (i.e., the identified spike), and Company B may be identified as having a corresponding $100,000 decrease in salary expenditures in the month of February (e.g., from $100,000 in total salary expenditures in January to $0 in February).

Having identified the first business customer (Company A) having a spike in monthly expenditures and the second business customer (Company B) having a corresponding decrease in monthly expenditures, data analysis logic 122 may determine that a merger involving the first business customer and the second business customer has occurred (e.g., data analysis logic 122 may store data indicating that Company A purchased Company B). In certain embodiments, the merger determination may be confirmed using publicly-available financial information 120 (e.g., news releases or other suitable financial information). The ability to identify corporate mergers and acquisitions may allow an enterprise (e.g., a financial institution) to better manage credit risk by allowing the enterprise to review and/or revise a credit risk rating of the acquiring company such that it accounts for the credit risk rating of the acquired company.

Although data analysis logic 122 has been described above as analyzing a particular type of business transaction data 118 to determine a list of mergers or acquisitions, the present disclosure contemplates analysis of any suitable business transaction data 118 maintained by an enterprise to determine a list of mergers or acquisitions.

In certain embodiments, data analysis logic 122 may be operable to analyze business transaction data 118 and publicly-available financial information 120 to determine a list of rapidly-growing businesses. For example, publicly-available financial information 120 may include yearly revenue data for a number of businesses (e.g., publicly-available financial information 120 may include reports generated by Dun and Bradstreet, information compiled by the SEC, etc.). Data analysis logic 122 may analyze this publicly-available financial information 120 to generate a list of businesses whose current year revenue exceeds a base year revenue (e.g., the businesses revenue in any other suitable year, such as five years prior to the current year) by more than a specified amount (referred to herein as a list of rapidly-growing businesses). As one particular example, data analysis logic 122 may analyze the publicly-available financial information 120 to determine those businesses whose current year revenue is more than twice that of the revenue five years prior to the current year.

Having determined the list of rapidly-growing businesses based on publicly-available financial information 120, data analysis logic 122 may be further operable to determine a subset of the list of rapidly-growing businesses that are current or former customers of the enterprise. For example, data analysis logic 122 may compare the list of rapidly-growing businesses with business transaction data 118 as the existence of business transaction data 118 for a particular business from the list of rapidly-growing businesses indicates that the particular business is a current or former customer of the enterprise. As one particular example, data analysis logic 122 may determine the subset of the list of rapidly-growing businesses by analyzing business transaction data 118 to locate tax IDs of the businesses from the list of rapidly-growing businesses (as both publicly-available financial information 120 and business transaction data 118 may indicate the tax ID of a business). As another particular example, data analysis logic 122 may utilize fuzzy matching logic to determine those businesses from the list of rapidly-growing businesses whose business name is stored in business transaction data 118.

Having determined the subset list of rapidly-growing businesses based on business transaction data 118, data analysis logic 122 may be further operable to categorize the businesses from the subset based on the strength of their relationship with the enterprise. In certain embodiments, data analysis logic 122 may analyze business transaction data 118 to determine the number of products currently being provided by the enterprise to each of the businesses from the subset. For example, businesses for which zero products are currently being provided may be classified as previous customers, businesses for which less than a specified number of products (e.g., three) are currently being provided may be classified as weak customers, and businesses for which more than the specified number of products are currently being provided may be classified as strong customers.

Determining the above-described categories of rapidly-growing businesses may allow an enterprise (e.g., a financial institution) to further develop existing relationships or develop new relationships with those businesses. For example, the enterprise may seek to develop a relationship with rapidly-growing businesses with which no previous relationship existed (i.e., those businesses include in the initial list but not included in the determined subset), resume the relationship with rapidly-growing businesses who are previous customers, and strengthen the relationship with rapidly-growing businesses who are weak customers.

Although data analysis logic 122 has been described above as analyzing particular types of publicly-available financial information 120 and business transaction data 118 to determine particular categories of rapidly-growing businesses, the present disclosure contemplates analysis of any suitable publicly-available financial information 120 and business transaction data 118 to determine any suitable categories of rapidly-growing businesses.

In certain embodiments, data analysis logic 122 may be operable to analyze business transaction data 118 and publicly-available financial information 120 to determine a list of small business customers that have grown beyond a certain size. For example, business transaction data 118 may include an internally-maintained classification for each of the customers of the enterprise (e.g., a classification identifying a business type, such as small business), which may have been determined based on revenue information for each of the customers. Data analysis logic 122 may analyze business transaction data 118 to determine a list of customers internally classified as small businesses.

Data analysis logic 122 may be further operable to access publicly-available financial information 120 for each of the businesses on the determined list of customers classified as small businesses (e.g., publicly-available financial information 120 may include reports generated by Dun and Bradstreet, information compiled by the SEC, etc.). For example, data analysis logic 122 may utilize fuzzy matching logic to locate publicly-available financial information 120 for each of the businesses on the determined list of customers classified as small businesses by matching business names. Based on the accessed publicly-available financial information 120, data analysis logic 122 may determine those businesses on the determined list of customers classified as small businesses who have a yearly revenue exceeding a predetermined amount (e.g., an amount indicating that a business should no longer be considered a small business, such as $5 million). Those businesses having a yearly revenue exceeding the predetermined amount may then be internally reclassified (e.g., as mid-level businesses rather than small businesses).

Because internal classifications for customers may govern the types of products that an enterprise (e.g., a financial institution) offers to those customers, knowledge of those small business customers that have grown beyond a certain size may allow the enterprise to reclassify those businesses (e.g., as mid-level business) such that appropriate products and/or services may be offered to those businesses.

Although data analysis logic 122 has been described above as analyzing particular types of publicly-available financial information 120 and business transaction data 118 to determine those small business customers that have grown beyond a certain size, the present disclosure contemplates analysis of any suitable publicly-available financial information 120 and business transaction data 118 to determine those small business customers that have grown beyond a certain size.

In certain embodiments, data analysis logic 122 may be operable to analyze business transaction data 118 and publicly-available financial information 120 to determine a list of potential mergers or acquisitions. For example, data analysis logic 122 may analyze business transaction data 118 to determine those customers who have a buyer-supplier relationship. As one particular example, data analysis logic 122 may analyze business transaction data 118 to determine correspondence between a first customer's expenditures and a second customer's revenues, such a correspondence indicating that the first customer is a buyer and the second customer is a supplier.

Data analysis logic 122 may be further operable to access publicly-available financial information 120 for each identified supplier (e.g., publicly-available financial information 120 may include reports generated by Dun and Bradstreet, information compiled by the SEC, etc.). For example, data analysis logic 122 may utilize fuzzy matching logic to locate publicly-available financial information 120 for each identified supplier by matching business names. The accessed publicly-available financial information 120 may include revenue information for each identified supplier.

Data analysis logic 122 may be further operable to determine those buyer-supplier relationships in which the expenditures from the buyer (as reflected in business transaction data 118) exceed a predetermined percentage (e.g., 30%) of the total yearly revenue for the supplier (as reflected in the accessed publicly-available financial information 120). In a buyer-supplier relationships satisfying this criteria, a merger or acquisition may be beneficial due to the dependence of the supplier on purchases from the buyer.

Knowledge of potential mergers or acquisitions, determined as described above, may allow an enterprise (e.g., a financial institution) to better assist in identifying merger/acquisition targets (e.g., to the investment banking industry).

Although data analysis logic 122 has been described above as analyzing particular types of business transaction data 118 and publicly-available financial information 120 to determine buyer-supplier relationships for which a merger or acquisition may be beneficial, the present disclosure contemplates analysis of any suitable business transaction data 118 and publicly-available financial information 120 to determine buyer-supplier relationships for which a merger or acquisition may be beneficial.

FIG. 2 illustrates an example method 200 for reclassifying small business customers, according to certain embodiments of the present disclosure. The method begins at step 202. At step 204, data analysis logic 122 of CAKP 104 may access business transaction data 118 for a plurality of customers of an enterprise. As described above, business transaction data 118 may include a size classification (e.g., a classification identifying a business type, such as small business, which may have been determined based on revenue information for each of the customers) for each of the plurality of customers of the enterprise.

At step 206, data analysis logic 122 may determine, based on the business transaction data, a first list of customers comprising one or more of the plurality of customers that have a particular size classification. As one particular example, data analysis logic 122 may analyze business transaction data 118 to determine a list of customers internally classified as small businesses. At step 208, data analysis logic 122 may access publicly-available financial information 120 for each of the one or more customers of the determined first list of customers. For example, data analysis logic 122 may utilize fuzzy matching logic to locate publicly-available financial information 120 for each of the one or more customers of the determined first list of customers by matching business names. As described above, the accessed publicly-available financial information 120 may include revenue information, such as that included in reports generated by Dun and Bradstreet, information compiled by the SEC, etc.

At step 210, data analysis logic 122 may determine, based on the accessed publicly-available financial information 120, a second list of customers comprising one or more customers of the first list of customers that have revenue exceeding a predetermined amount (e.g., a yearly revenue exceeding $5 million).

At step 212, data analysis logic 122 may store (e.g., in database 108 of CAKP 104) a new size classification for each of the one or more customers of the second list (e.g., as mid-level businesses rather than small businesses). The method ends at step 214.

Although the steps of method 200 have been described as being performed in a particular order, the present disclosure contemplates that the steps of method 200 may be performed in any suitable order, according to particular needs.

Although the present disclosure has been described with several embodiments, diverse changes, substitutions, variations, alterations, and modifications may be suggested to one skilled in the art, and it is intended that the invention encompass all such changes, substitutions, variations, alterations, and modifications as fall within the spirit and scope of the appended claims.

What is claimed is:

1. A system, comprising:
one or more memory modules operable to store business transaction data for a plurality of customers of an enterprise, the business transaction data including a size classification for each of the plurality of customers; and
one or more processing modules communicatively coupled to the one or more memory modules, the one or more processing modules operable to:
determine, based on the business transaction data, a first list of customers comprising one or more of the plurality of customers that have a particular size classification;
access publicly-available financial information for each of the one or more customers of the determined first list of customers, the publicly-available financial information including revenue information for each of the one or more customers of the determined first list of customers;
determine, based on the accessed publicly-available financial information, a second list of customers comprising one or more customers of the first list of customers that have revenue exceeding a predetermined amount;
store, in the one or more memory modules, a new size classification for each of the one or more customers of the second list.

2. The system of claim 1, wherein accessing publicly-available financial information for each of the one or more customers of the determined first list of customers comprises searching a database storing the publicly-available financial information to identify names of the one or more customers of the determined first list of customers using fuzzy matching logic.

3. The system of claim 1, wherein the particular size classification is a small-business classification.

4. The system of claim 1, wherein the predetermined amount of revenue is yearly revenue equal to or greater than five million dollars.

5. The system of claim 1, wherein the one or more processing modules are further operable to determine, based on the new size classification for each of the one or more customers of the second list, a set of products to be offered to each of the one or more customers of the second list.

6. The system of claim 1, wherein the accessed publicly-available financial information comprises, at least in part, data available in reports offered by Dun & Bradstreet, Inc.

7. A non-transitory computer-readable medium encoded with logic, the logic operable when executed by a processor to:
access business transaction data for a plurality of customers of an enterprise, the business transaction data including a size classification for each of the plurality of customers;
determine, based on the business transaction data, a first list of customers comprising one or more of the plurality of customers that have a particular size classification;
access publicly-available financial information for each of the one or more customers of the determined first list of customers, the publicly-available financial information including revenue information for each of the one or more customers of the determined first list of customers;
determine, based on the accessed publicly-available financial information, a second list of customers comprising one or more customers of the first list of customers that have revenue exceeding a predetermined amount;
store a new size classification for each of the one or more customers of the second list.

8. The computer-readable medium of claim 7, wherein accessing publicly-available financial information for each of the one or more customers of the determined first list of customers comprises searching a database storing the publicly-available financial information to identify names of the one or more customers of the determined first list of customers using fuzzy matching logic.

9. The computer-readable medium of claim 7, wherein the particular size classification is a small-business classification.

10. The computer-readable medium of claim 7, wherein the predetermined amount of revenue is yearly revenue equal to or greater than five million dollars.

11. The computer-readable medium of claim 7, wherein the logic is further operable when executed to determine, based on the new size classification for each of the one or more customers of the second list, a set of products to be offered to each of the one or more customers of the second list.

12. The computer-readable medium of claim 7, wherein the accessed publicly-available financial information comprises, at least in part, data available in reports offered by Dun & Bradstreet, Inc.

13. A method, comprising:
accessing business transaction data for a plurality of customers of an enterprise, the business transaction data including a size classification for each of the plurality of customers;
determining, based on the business transaction data and using one or more processing modules, a first list of customers comprising one or more of the plurality of customers that have a particular size classification;
accessing publicly-available financial information for each of the one or more customers of the determined first list of customers, the publicly-available financial information including revenue information for each of the one or more customers of the determined first list of customers;
determining, based on the accessed publicly-available financial information and using the one or more processing modules, a second list of customers comprising one or more customers of the first list of customers that have revenue exceeding a predetermined amount;
storing a new size classification for each of the one or more customers of the second list.

14. The method of claim 13, wherein accessing publicly-available financial information for each of the one or more customers of the determined first list of customers comprises searching a database storing the publicly-available financial information to identify names of the one or more customers of the determined first list of customers using fuzzy matching logic.

15. The method of claim 13, wherein the particular size classification is a small-business classification.

16. The method of claim 13, wherein the predetermined amount of revenue is yearly revenue equal to or greater than five million dollars.

17. The method of claim 13, further comprising determining, based on the new size classification for each of the one or more customers of the second list, a set of products to be offered to each of the one or more customers of the second list.

18. The method of claim 13, wherein the accessed publicly-available financial information comprises, at least in part, data available in reports offered by Dun & Bradstreet, Inc.
